(19) United States
(12) Patent Application Publication
(10) Pub. No.: US 2020/0238549 A1
(43) Pub. Date: Jul. 30, 2020

(54) GROOMING DEVICE

(71) Applicant: Steven Abramsky, Cuba City, WI (US)

(72) Inventor: Steven Abramsky, Cuba City, WI (US)

(21) Appl. No.: 16/751,885

(22) Filed: Jan. 24, 2020

Related U.S. Application Data
(60) Provisional application No. 62/796,682, filed on Jan. 25, 2019.

(51) Int. Cl. B26B 19/38; A45D 44/00

(52) U.S. Cl. CPC B26B 19/3853; A45D 2200/1054; B26B 19/3846; A45D 44/00

(57) ABSTRACT

A grooming device having a housing with a blade receiving section and a handle section. A blade is disposed within the blade receiving section of the housing and retained within the housing by a removable cap. The handle section is removably connected to a holder. Preferably, the housing has a circular top edge and bottom edge that have diameters greater than a transition section in-between.

### CROSS REFERENCE TO RELATED APPLICATION

This application claims the benefit of U.S. Provisional Application No. 62/796,682 filed Jan. 25, 2019, the contents of this application is hereby incorporated by reference in its entirety.

### BACKGROUND OF THE INVENTION

The present invention is directed to a grooming device and more particularly a grooming device for use with shaving and exfoliating.

Shaving devices are well-known in the art. Many of these devices are complex in their design, require unidirectional movement, cause skin irritation through microscopic sheering along the skin's surface, get hairs caught between the blades and often require replacement blades when the original blades become worn. Some choose to replace the entire disposable shaving device, rather than the blade alone, causing environmental damage. Not only are these devices cumbersome and inefficient, but the majority are limited to the single use of shaving. Accordingly, there is a need in the art for a device that addresses these deficiencies.

An objective of the present invention is to provide a grooming device that is compact and efficient to use.

Another objective of the present invention is to provide a grooming device adapted for multiple users and use cases.

These and other objectives will be apparent to those having ordinary skill in the art based upon the following written description, drawings, and claims.

### SUMMARY OF THE INVENTION

A grooming device has a housing having a blade receiving section and a handle section. Preferably, the blade receiving section is cone or funnel shaped and extends from a circular top edge to a middle wall to form a chamber for collecting hair. The handle section combined with the blade receiving section preferably form a cake stand shape with a transition section having a diameter smaller than the top edge and a bottom edge of the housing.

A blade is disposed within the blade receiving section of the housing, is preferably circular, and has a plurality of holes that fill a surface area of the blade. The blade is also concave in relation to the middle wall.

The blade is retained within the blade receiving section by a cap that is removably connected to the housing. Preferably the cap is ring shaped with a central opening. An exfoliating cover can be placed over the cap to provide additional applications for the device.

The handle section is removably connected to a holder. Preferably, both the handle section and the holder have magnets that attract one another.

### BRIEF DESCRIPTION OF THE DRAWINGS

FIG. 1 is an exploded perspective view of a grooming device;

FIG. 2 is a side sectional view of a housing of a grooming device;

FIG. 3 is a side view of a blade of a grooming device;

FIG. 4 is a top plan view of a housing of a grooming device;

FIG. 5 is a side view of a portion of a grooming device; and

FIG. 6 is a side view of a blade for a grooming device.

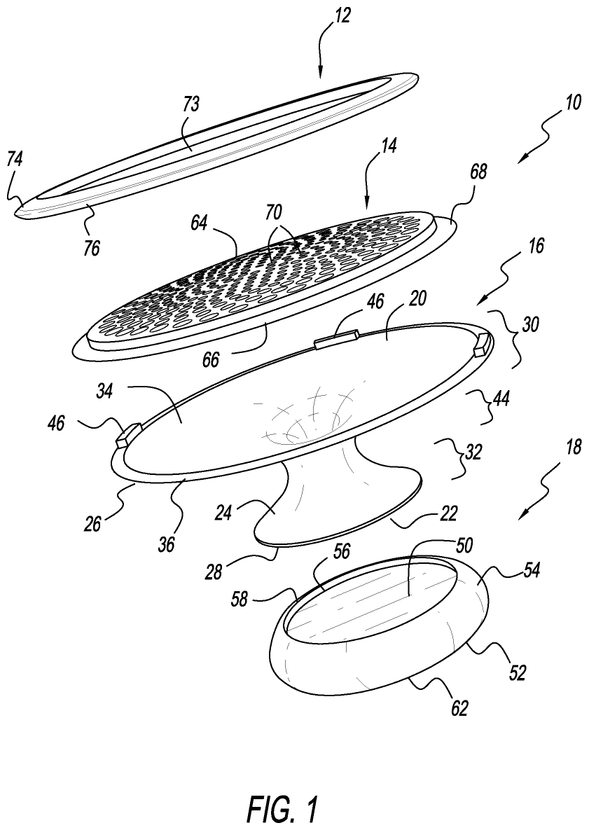

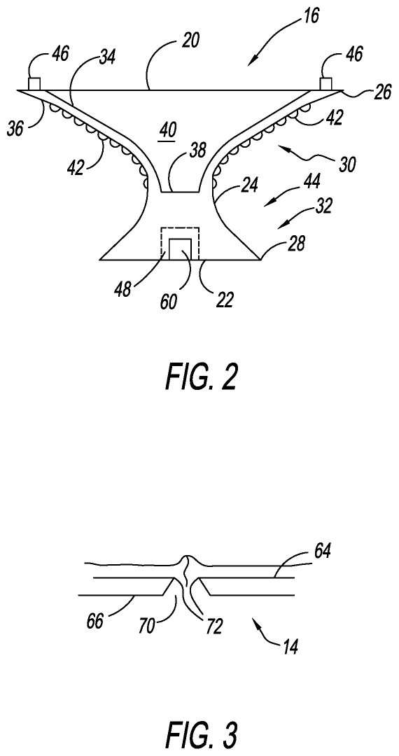

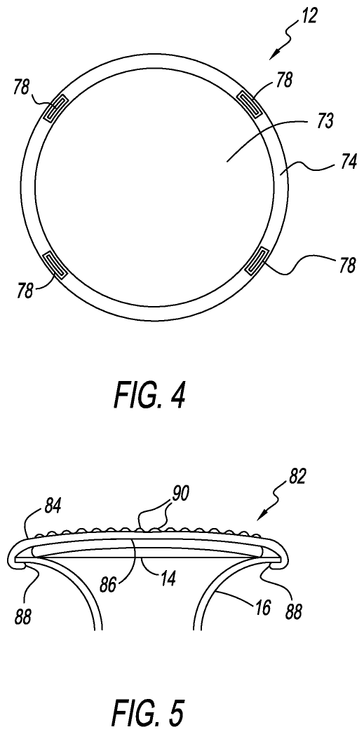

### DETAILED DESCRIPTION OF THE PREFERRED EMBODIMENTS

Referring to the Figures, a grooming device 10 includes a cap 12, a blade or foil 14, a housing 16, and a holder 18. The housing 16 has an open top 20, a bottom 22, and a side wall 24. Preferably, the side wall 24 extends from a top edge 26 to a bottom edge 28 in a curved manner that is concave to a central vertical axis of the housing 16 to form a blade receiving section 30 and a handle section 32.

The blade receiving section 30 has an inner surface 34 and an outer surface 36. The inner surface 34 curves from the top edge 26 to a middle wall 38 that forms a chamber 40 for collecting cut hair. The outer surface 36 has a plurality of raised or lowered portions 42 to provide an anti-slip surface. The diameter of the top edge 26 is greater than the bottom edge 28 and both are larger than a diameter of a transition section 44 that dwells in between. The design is adapted to permit one to hold the housing 16 by grasping the transition section 44 with a finger on both sides while engaging the back surface 36 of the blade receiving section 30 and the handle section 32. Attached to and extending vertically away from the top edge 26 are a plurality of radially spaced projections or clips 46. The handle section 32 has a magnet 48 attached to or preferably embedded within the handle section 32.

The handle section 32 of housing 16 is removably connected to the holder 18. The holder 18 is of any size, shape, and structure. In the example shown, the holder 18 has a top 50, a bottom 52, and an arcuate concave side wall 54. The side wall 54 has a top edge 56 that curves above the top 50 and forms a shoulder 58. The top edge 56 has a diameter adapted to receive the bottom edge 28 of the handle portion 32. Attached to, and preferably embedded within, the holder 18 is a magnet 60. Attached to the bottom 52 of the holder 18 is a layer of adhesive material 62 adapted to permit the holder 18 to adhere to a support object such as a shower wall. The housing 16 is made of a single piece, or alternatively the blade retaining section and handle section are made as separate pieces that connect together.

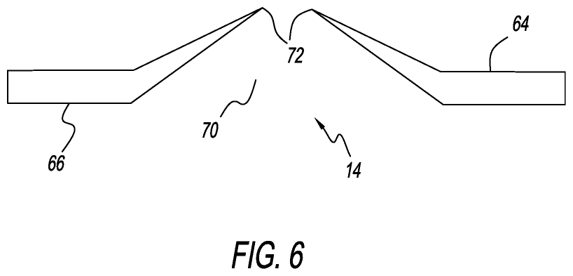

The blade 14 has a convex shape in relation to the housing 16 and a diameter smaller than the diameter of the top edge 26 of the housing 16 so that the blade 14 engages the inner surface 34 of the housing 16 within the clips 46. The convex shape permits the blade to engage with hard to reach areas that a flat blade would not be able to reach, increase the surface area shaved compared to conventional flat blades, and facilitates material flexibility to contour to the body's surface. The blade 14 has a top surface 64, a bottom surface 66, and an outer edge 68. A plurality of holes 70 extend from the top surface 64 through to the bottom surface 66 that can be manufactured in any shape, size, and configuration, and allow for movement in any direction to cut hairs while maintaining safety of the user. Preferably, the holes 70 angle inwardly as they extend from the bottom 66 to the top 64 to form a sharp cutting edge 72. Alternatively, the holes 70 extend beyond the top 64 to form a sharp cutting edge as shown in FIG. 6. Preferably, the holes 70 fill the entire area within the outer edge 68, with the holes 70 closer to the center having a diameter smaller than holes 70 closer to the outer edge 68. Having a larger diameter permits the holes 70 to capture longer hairs.

The cap 12 is removably connected to the housing 16 and is adapted to retain the blade 14 between the cap 12 and the housing 16. The cap 12 is of any size, shape, and structure. In the example shown, the cap 12 is formed as a ring with an open center 73, a top surface 74, and a bottom surface 76. The top surface 74 preferably is smooth and the bottom surface 76 has a plurality of grooves 78. The grooves 78 are positioned to align with, and adapted to receive, the clips 46 on the top edge 26 of the housing 16 to frictionally connect the cap 12 to the housing 16 through means of threading, snap on, or twist on. The cap 12 has a width that traps and retains the blade 14 between the bottom surface 76 of the cap 12 and the inner surface 34 of the blade receiving section 30 of the housing 16. In one example, the cap is secured to the housing through use of a magnet, friction fit, or similar type of removable connection.

In operation, a plurality of blades 14 are provided in a stack with a plastic layer of material adhered with adhesive or the like to the top surface 64 of each blade 14. The plastic layer 78 is removed and the blade 14 is placed within the blade receiving section 30 of the housing 16 so that the bottom surface 66 of the blade 14 engages the inner surface 34 of the blade retaining section 30. The cap 12 is then attached to the housing 16 to retain the blade 14 by positioning the grooves 78 over the clips 46 and pressing down or twisting if threaded or bayonet style.

Once assembled, the device 10 is held between the fingers at the transition section 44 as previously described and the top surface 64 of the blade 14, through the open center 73, engages one's skin and as the blade 14 is moved across the skin, hair is cut by the cutting edge 72. The cut hair falls from the blade 14 and into chamber 40 of the blade receiving section 30. The cut hair is removed when the blade 14 is replaced.

An exfoliating cover 82 can be placed over the cap 12 to exfoliate one's skin. The cover 82 has a top surface 84, a bottom surface 86, and an outer edge 88. The top surface 84 has a plurality of nubs or fingers 90 that extend outwardly away from the bottom surface 86. Preferably the cover 82 is made of a resilient material and the outer edge 88 curves back and dwells below the bottom surface. To attach the cover 82 the outer edge 88 is stretched to fit over the top edge 26 of the housing 16 and then released so that the bottom surface 86 of the cover 82 engages the top surface 64 of the cap 12 and the outer surface 36 of the blade retaining section 30 of the housing 16.

When not in use, the device 10 is stored by attaching the device 10 to the holder 18. As an example, the bottom edge 28 of the housing 16 is placed within the shoulder 58 of the holder 18 so that the handle section 32 engages the top 50 of the holder 18. The magnet 48 in the handle section 32 is attracted to the magnet 60 in the holder 18 to hold the device 10 in place.

The magnets can be insert molded, over molded, or friction fit and a single magnet used with an opposing magnet material. Also, when not in use, a protective guard is placed over the cap in similar manner to the exfoliating cover.

From the above discussion and accompanying figures and claims it will be appreciated that the grooming device 10 offers many advantages over the prior art. It will be appreciated further by those skilled in the art that other various modification could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A grooming device comprising:
a housing having a blade receiving section and a handle section;
a blade disposed within the blade receiving section of the housing;
a cap removably connected to the housing and adapted to retain the blade between the cap and the housing; and
the handle section of the housing removably connected to a holder.

2. The device of claim 1 wherein the blade has a convex shape in relation to the housing and a diameter smaller than a diameter of a top edge of the housing.

3. The device of claim 1 wherein the blade has a plurality of holes that fill an entire area within an outer edge of the blade.

4. The device of claim 3 wherein the plurality of holes closer to a center of the blade have a diameter smaller than the plurality of holes closer to the outer edge of the blade.

5. The device of claim 1 wherein the cap is formed as a ring with an open center.

6. The device of claim 1 wherein the housing has a top edge and a bottom edge wherein the diameter of both the top edge and the bottom edge are greater than a transition section that dwells in-between.

7. The device of claim 1 wherein the holder has a magnet.

8. The device of claim 1 wherein the handle section of the housing has a magnet.

9. The grooming device of claim 1 further comprising an exfoliating cover placed over the cap.
